(19) United States
(12) Patent Application Publication
(10) Pub. No.: US 2018/0374022 A1
(43) Pub. Date: Dec. 27, 2018

(54) METHODS AND SYSTEMS FOR IMPROVED QUALITY INSPECTION

(71) Applicant: MIDEA GROUP CO., LTD., Foshan City (CN)

(72) Inventors: Dongyan Wang, San Jose, CA (US); Haisong GU, Cupertino, CA (US)

(21) Appl. No.: 15/633,443

(22) Filed: Jun. 26, 2017

(51) Int. Cl. G06Q 10/06; G06N 5/02; G06T 7/00; G06K 9/62; H04N 5/247; H04N 5/33; H04N 13/02

(52) U.S. Cl. CPC G06Q 10/06395; G06N 5/022; G06T 7/001; G06K 9/6215; B25J 19/023; H04N 5/33; H04N 13/0203; G06T 2207/10016; G06T 2207/10116; H04N 5/247

(57) ABSTRACT

A method of identifying product defects on a production line includes receiving data from a plurality of edge devices monitoring a product on a production line for product defects. The data includes unique perspectives of the product captured by the edge devices. The method further includes generating an overall view of the product by merging each unique perspective of the product captured by respective edge devices of the plurality, and comparing the overall view with characteristic(s) of the product. Based on the comparing, the method further includes determining whether a degree of difference between the overall view and the characteristic(s) satisfies one or more criteria, and upon determining that the degree of difference between the overall view and the characteristic(s) satisfies at least one criterion of the one or more criteria, recording and reporting a defect associated with the product according to the difference between the view and the characteristic(s).

### TECHNICAL FIELD

This relates generally to production lines, including but not limited to visually inspecting products and operators of production lines.

### BACKGROUND

Manufacturers implement various quality control measures to reduce the amount of defective products that enter the stream of commerce. Some quality control measures involve human workers and/or devices visual inspecting products. However, current visual inspection techniques invariably miss defective products and also lack procedures to account for new product defects (e.g., product defects caused by an aging production line). As such, challenges exists in initially identifying product defects, especially product defects that develop over the life of the production line, and identifying a root cause of those new product defects (e.g., identifying an operation that caused the product defect).

### SUMMARY

Accordingly, there is a need for methods and systems for: (i) initially identifying defective products before the defective products enter the stream of commerce, and (ii) identifying a root cause of the defect (e.g., using data gathered from the defective products). In this way, a manufacturer is able to further reduce an amount of defective products entering the stream of commerce while also uncovering the root cause of the defect in such a manner that manufacturing down time is also reduced.

(A1) In some implementations, a method of improved quality inspection includes, at a server system (e.g., server system 200, FIG. 2) having one or more processors and memory storing instructions for execution by the processors, receiving data from a plurality of edge devices (e.g., edge devices 410-1, 410-2, 410-3, . . . 410-n, FIG. 4A) monitoring a product (e.g., product 408, FIG. 4A) on a production line (e.g., production line 400, FIG. 4A) for product defects. The data includes unique perspectives of the product captured by the plurality of edge devices (e.g., unique perspectives 430 (FIG. 4B), 440 (FIG. 4C), and 450 (FIG. 4D)). The method further includes generating an overall view of the product by merging each unique perspective of the product captured by respective edge devices of the plurality of edge devices and comparing the overall view with one or more characteristics of the product. Based on the comparing, the method further includes determining whether a degree of difference between the overall view and the one or more characteristics satisfies one or more criteria, and upon determining that the degree of difference between the overall view and the one or more characteristics satisfies at least one criterion of the one or more criteria, recording and reporting a defect associated with the product according to the difference between the overall view and the one or more characteristics.

(A2) In some implementations of the method of A1, the method further includes, at the server system, providing a classification model to each of the plurality of edge devices for monitoring the product on the production line for product defects. The classification model includes one or more identified defects associated with the product and the edge device is configured to compare a unique perspective of the product with the classification model and include a corresponding comparison result in the data to be submitted to the server system.

(A3) In some implementations of the method of A2, the method further includes, at the server system, after recording and reporting the defect: (i) updating the classification model to include the defect as part of the one or more identified defects associated with the product, and (ii) providing the updated classification model to the plurality of edge devices. Each of the plurality of edge devices uses the updated classification model for monitoring the product on the production line for product defects.

(A4) In some implementations of the method of any of A1-A3, the data received from the plurality of edge devices spans a period of time, the production line includes at least one operation on the product, and the data further includes a gesture sequence of an operator associated with the at least one operation captured by at least one edge device (e.g., edge devices 506-1, 506-2, . . . 506-n, FIG. 5) of the plurality of edge devices during the period of time.

(A5) In some implementations of the method of A4, the method further includes, at the server system, comparing the gesture sequence of the operator with a predefined gesture sequence corresponding to the operator. Based on the comparing, determining whether a degree of difference between the gesture sequence of the operator and the predefined gesture sequence satisfies a threshold and in accordance with a determination that the degree of difference between the gesture sequence of the operator and the predefined gesture sequence satisfies the threshold, recording and reporting the operator as being associated with the defect.

(A6) In some implementations of the method of A5, the operator associated with the at least one operation is a robot, and recording and reporting the operator includes updating a program defining the gesture sequence of the robot.

(A7) In some implementations of the method of A6, the updated program provided to the robot is updated based, at least in part, on the degree of difference between the gesture sequence of the operator and the predefined gesture sequence.

(A8) In some implementations of the method of A6, the updated program provided to the robot is updated based, at least in part, on the degree of difference between a portion of the gesture sequence of the operator and a corresponding portion of the predefined gesture sequence.

(A9) In some implementations of the method of A5, the operator associated with the at least one operation is a human operator, recording and reporting the operator includes providing a report to the human operator, and the report includes portions of the data received from the plurality of edge devices.

(A10) In some implementations of the method of A5, the method further includes, at the server system, before comparing the gesture sequence of the operator with a predefined gesture sequence corresponding to the operator, applying a dynamic time wrapping (DTW) process to the gesture sequence of the operator. The DTW process normalizes a temporal difference between the predefined gesture sequence and the gesture sequence of the operator. As such, determining the degree of difference between the gesture sequence of the operator and the predefined gesture sequence is performed to the normalized temporal difference.

(A11) In some implementations of the method of any of A1-A10, the data received from the plurality of edge devices includes images of each unique perspective of the product captured by respective edge devices of the plurality of edge devices. As such, merging each unique perspective of the product includes merging at least some of the images captured by respective edge devices of the plurality of edge devices according to their respective physical locations along the production line to generate the overall view.

(A12) In some implementations of the method of any of A1-A11, the overall view is a post-operation overall view and the data received from the plurality of edge devices includes: (i) a first sequence of images from each unique perspective of the product captured by a first set of edge devices of the plurality of edge devices before an operation, and (ii) a second sequence of images from each unique perspective of the product captured by a second set of edge devices of the plurality of edge devices after the operation. Moreover, the method further includes, at the server system, generating a pre-operation overall view of the product using the first sequence of images (the post-operation overall view is generated using the second sequence of images). Accordingly, at least some of the one or more characteristics of the product are captured in the pre-operation overall view.

(A13) In some implementations of the method of any of A1-A12, the method further includes, at the server system, classifying the defect associated with the product based at least part on (i) the data received from the plurality of edge devices and (ii) the at least one criterion. Based on the classification, identifying at least one operation of the production line responsible for the defect.

(A14) In some implementations of the method of any of A1-A13, the production line includes at least first and second operations, the data includes: (i) first unique perspectives of the product after the first operation captured by a first set of the plurality of edge devices, and (ii) second unique perspectives of the product after the second operation captured by a second set of the plurality of edge device, and the overall view is a first overall view of the first unique perspectives of the product after the first operation. The method further includes, at the server system, generating a second overall view of the product by merging each second unique perspective of the product captured by the second set of edge devices.

(A15) In some implementations of the method of any of A1-A14, the plurality of edge devices includes one or more of: a camera, an infrared camera, an X-ray camera, and a depth camera.

(A16) In another aspect, a server system is provided (e.g., server system 200, FIG. 2). The server system includes one or more processors, and memory storing one or more programs, which when executed by the one or more processors cause the server system to perform the method described in any one of A1-A15.

(A17) In yet another aspect, a server system is provided and the server system includes means for performing the method described in any one of A1-A15.

(A18) In still another aspect, a non-transitory computer-readable storage medium is provided. The non-transitory computer-readable storage medium stores executable instructions that, when executed by a server system (e.g., server system 200, FIG. 2) with one or more processors/cores, cause the server system to perform the method described in any one of A1-A15.

### BRIEF DESCRIPTION OF THE DRAWINGS

For a better understanding of the various described implementations, reference should be made to the Description of Embodiments below, in conjunction with the following drawings in which like reference numerals refer to corresponding parts throughout the figures and specification.

FIG. 1 is a block diagram illustrating an exemplary network architecture of an intelligent production line, in accordance with some implementations.

FIG. 2 is a block diagram illustrating an exemplary server system, in accordance with some implementations.

FIG. 3 is a block diagram illustrating an exemplary edge device, in accordance with some implementations.

FIG. 4A is an exemplary arrangement of a plurality of edge devices on a production line, in accordance with some implementations.

FIGS. 4B-4D are unique perspectives captured by the plurality of edge devices of a product on the production line, in accordance with some implementations.

FIG. 5 is an exemplary arrangement of a plurality of edge devices on a production line that includes a robot operator, in accordance with some implementations.

FIGS. 6A-6B are unique perspectives captured by the plurality of edge devices of the robot operator, in accordance with some implementations.

FIG. 7 is an exemplary three-dimensional model of movements of an operator during a period of time, in accordance with some implementations.

FIG. 8 is a flow diagram illustrating a method of improved quality inspection on a production line, in accordance with some implementations.

### DESCRIPTION OF EMBODIMENTS

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are used only to distinguish one element from another. For example, a first edge device could be termed a second edge device, and, similarly, a second edge device could be termed a first edge device, without departing from the scope of the various described implementations. The first edge device and the second edge device are both edge devices, but they are not the same edge devices.

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

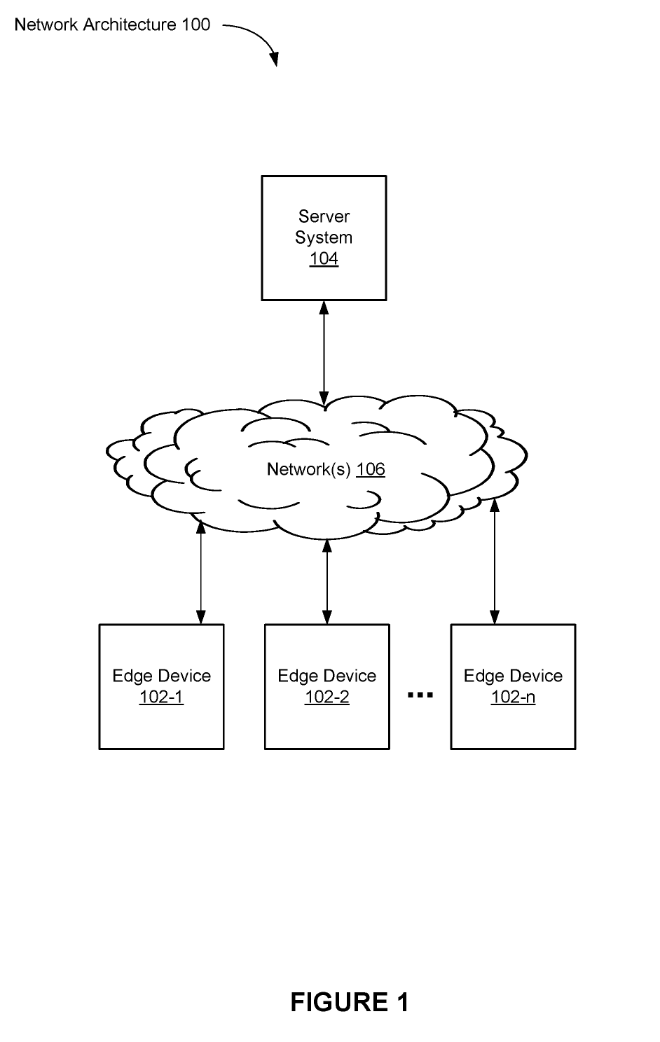

FIG. 1 is a block diagram illustrating an exemplary network architecture 100 of a product and operator inspection network in accordance with some implementations. The network architecture 100 includes a number of edge devices 102-1, 102-2, . . . 102-n communicably connected to a server system 104 by one or more networks 106.

In some implementations, the edge devices 102-1, 102-2, . . . 102-n are electronic devices that can communicate with the server system 104, each other, and other devices. In some implementations, the server system 104 is a single computing device such as a computer server, while in other implementations, the server system 104 is implemented by multiple computing devices working together to perform the actions of a server system (e.g., cloud computing). In some implementations, the network 106 is a public communication network (e.g., the Internet or a cellular data network), a private communications network (e.g., private LAN or leased lines), or a combination of such communication networks.

The edge devices 102-1, 102-2, . . . 102-n are used to inspect (e.g., monitor) a production line for product defects. In some implementations, the edge devices 102-1, 102-2, . . . 102-n monitor an operation of the production line (e.g., monitor movements of an operator). In some implementations, the edge devices 102-1, 102-2, . . . 102-n monitor an operation's effect on a product (e.g., perform quality control). The edge devices 102-1, 102-2, . . . 102-n capture unique perspectives of the operation (e.g., capture unique perspectives of a product and/or unique perspectives of an operator performing an operation). To do this, each of the edge devices 102-1, 102-2, . . . 102-n includes one or more capture devices, such as a camera, an infrared camera, an X-ray camera, a depth camera, etc. The goal being that the edge devices 102-1, 102-2, . . . 102-n first identify product defects (or collect data that can be used to identify product defects), and subsequent identify the cause the product defect.

In some implementations, the edge devices 102-1, 102-2, . . . 102-n send the captured data to the server system 104. The server system 104 can use the received data to generate an overall view of the product by merging each unique perspective of the product captured by the edge devices 102-1, 102-2, . . . 102-n. For example, the server system 104 may create a three-dimensional model of the product using the unique perspectives of the product captured by the edge devices 102-1, 102-2, . . . 102-n. In this way, the server system 104 creates a model of each product created on the production line and uses the model to identify product defects.

In addition, in some implementations, the server system 104 can use the received data to compare movements of an operator (referred to herein as a gesture sequence) with template (or reference) movements of the operator (referred to herein as a predefined gesture sequence). Based on the comparison, the server system 104 is able to identify a specific part (or multiple parts) of the operator that deviates from the predefined gesture sequence, and likely caused the product defect. In this way, a defective product is identified before entering the stream of commerce. Moreover, the cause of the defect is identified and remedied, thereby reducing downtime.

In some implementations, the network architecture 100 may also include third-party servers (not shown). In some implementations, third-party servers are associated with third-party service providers that provide additional data the server system 104 (e.g., weather data and personnel data).

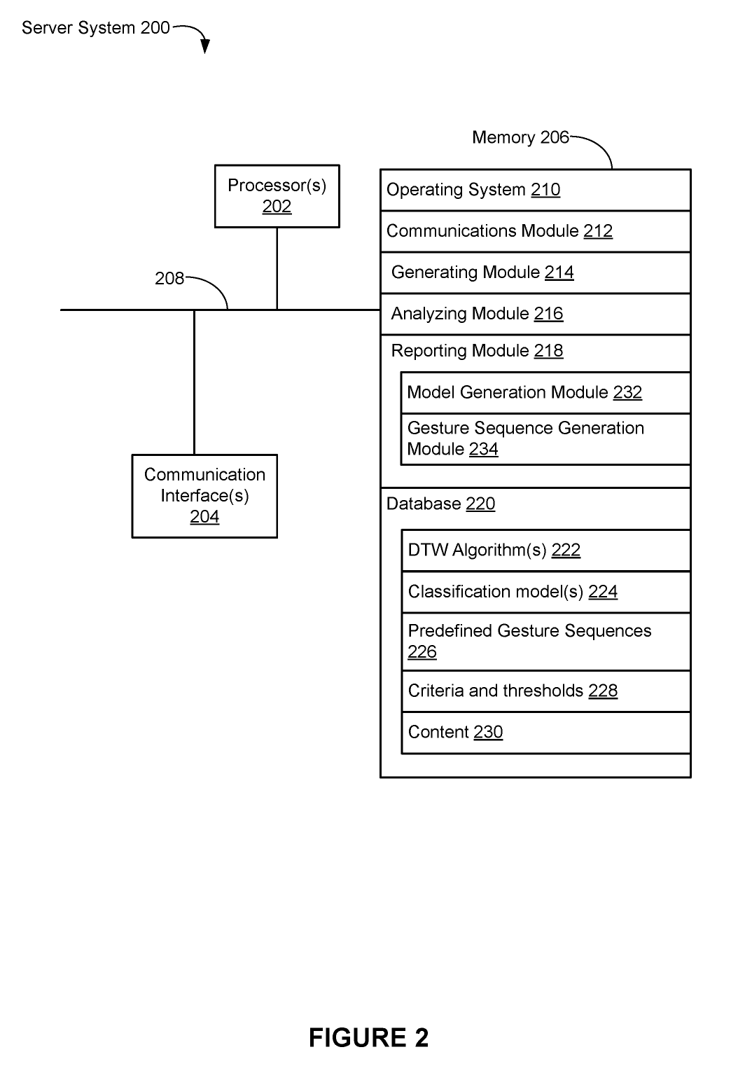

FIG. 2 is a block diagram illustrating an exemplary server system 200 in accordance with some implementations. In some implementations, the server system 200 is an example of a server system 104 (FIG. 1). The server system 200 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The server system 200 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 206 includes high-speed random access memory, such as DRAM, SRAM, DDR RAM, or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the processor(s) 202. Memory 206, or alternately the non-volatile memory device(s) within memory 206, includes a non-transitory computer readable storage medium. In some implementations, memory 206 or the computer readable storage medium of memory 206 stores the following programs, modules, and data structures, or a subset or superset thereof:
an operating system 210 that includes procedures for handling various basic system services and for performing hardware-dependent tasks;
a network communication module 212 that is used for connecting the server system 200 to other computers (e.g., edge devices 102-1, 102-2, . . . 102-n, and/or third party servers) via the one or more communication network interfaces 204 (wired or wireless) and one or more communication networks 106 (FIG. 1), such as the Internet, cellular telephone networks, mobile data networks, other wide area networks, local area networks, metropolitan area networks, and so on;
a generating module 214 that is used for processing data received from one or more edge devices and for generating views (e.g., two-dimensional views, three-dimensional views, etc.) of a product using the data received from the one or more edge devices;
an analyzing module 216 that is used for analyzing the processed data, the views generated by the generating module 214, and comparing the processed data with templates (e.g., characteristics of a product and/or predefined gesture sequences);
a reporting module 218 that is used for recording and reports defects (e.g., after determining a degree of difference between the overall view and the one or more characteristics satisfies one or more criteria); and
a server database 220 for storing data associated with the server system, such as:
   one or more dynamic time wrapping processes 222;
   one or more classification models 224;
   one or more predefined gesture sequences 226;
   one or more criteria and thresholds 228; and
   content 230.

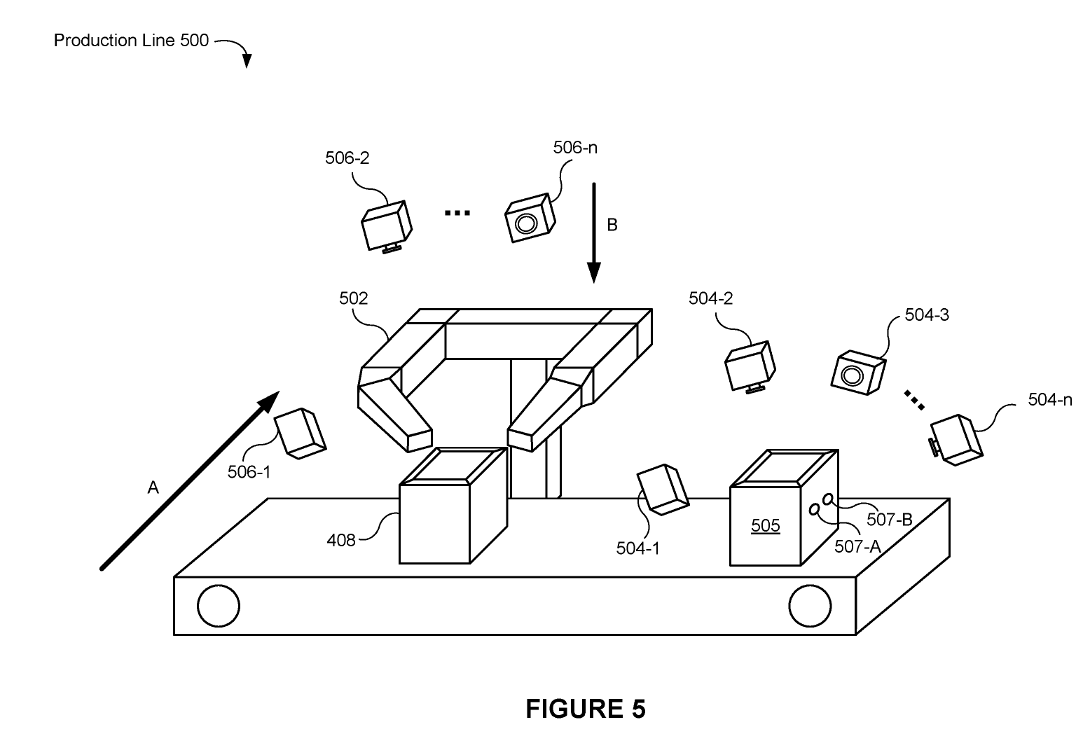

In some implementations, the reporting module 218 includes a classification model generation module 232 and a gesture sequence generation module 234. The classification model generation module 232 is used for generating and updating classification models that are provide to the edge devices. The gesture sequence generation module 234 is used for generating and updating gesture sequences provided to a robot (e.g., robot 502, FIG. 5). For example, the gesture sequence may be a program used by the robot to perform an operation. In addition, the gesture sequence generation module 234 is used for generating the predefined gesture sequences.

The content 230 can include data received from the edge devices, such as unique perspectives captured by the edge devices. In addition, the content 230 can include models and views generated by the server system (or models and views received from one or more edge devices). In some implementations, the content 230 includes text (e.g., ASCII, SGML, HTML), images (e.g., jpeg, tif and gif), graphics (e.g., vector-based or bitmap), audio, video (e.g., mpeg), other multimedia, and/or combinations thereof.

The server database 220 stores data associated with the server system 200 in one or more types of databases, such as text, graph, dimensional, flat, hierarchical, network, object-oriented, relational, and/or XML databases.

In some implementations, the server system 200 stores in memory a graph of the edge devices. For example, the graph identifies each edge device on a particular production line and connections between each edge device. The connections may include a position of the edge device, an orientation of the edge device, neighboring edge devices, etc. By maintaining the graph, the server system 200 is able to determine how unique perspectives relate to one another.

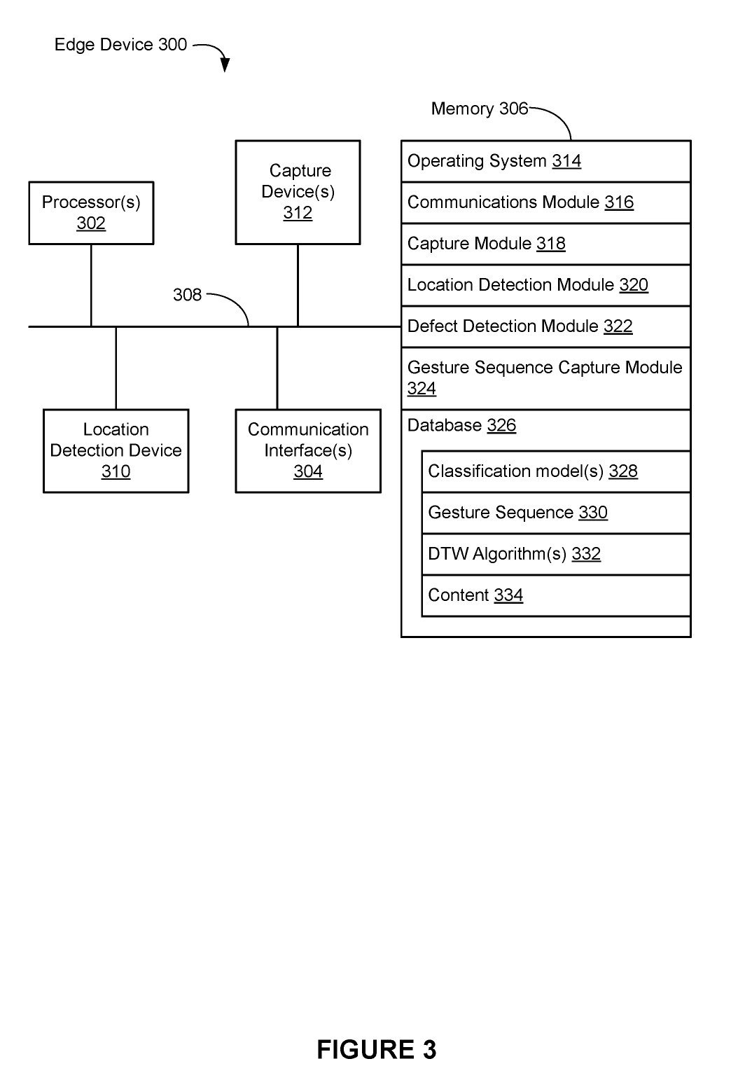

FIG. 3 is a block diagram illustrating an exemplary edge device 300, in accordance with some implementations. The edge device 300 is an example of the one or more edge devices 102-1, 102-2, . . . 102-n (FIG. 1). The edge device 300 typically includes one or more processing units (processors or cores) 302, one or more network or other communications interfaces 304, memory 306, and one or more communication buses 308 for interconnecting these components. The communication buses 308 optionally include circuitry (sometimes called a chipset) that interconnects and controls communications between system components. The edge device 300 includes a location detection device 310, such as a GNSS (e.g., GPS, GLONASS, etc.) or other geo-location receiver, for determining the location of the edge device 300. The edge device 300 also includes one or more capture devices 312, such as a camera, an infrared camera, an X-ray camera, a depth camera, a three-dimensional camera, and the like.

In some implementations, the client device 300 includes one or more optional sensors (e.g., gyroscope, accelerometer) for detecting motion and/or a change in orientation of the edge device 300. In some implementations, the detected motion and/or orientation of the edge device 300 is used to indicate that the edge device 300 requires adjusting or realigning.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 306 may optionally include one or more storage devices remotely located from the processor(s) 306. Memory 306, or alternately the non-volatile memory device(s) within memory 306, includes a non-transitory computer-readable storage medium. In some implementations, memory 306 or the computer-readable storage medium of memory 306 stores the following programs, modules, and data structures, or a subset or superset thereof:
an operating system 314 that includes procedures for handling various basic system services and for performing hardware-dependent tasks;
a network communication module 316 that is used for connecting the edge device 300 to other computers (e.g., other edge devices and the server system 200) via the one or more communication network interfaces 304 (wired or wireless) and the one or more communication networks 106 (FIG. 1), such as the Internet, cellular telephone networks, mobile data networks, other wide area networks, local area networks, metropolitan area networks, and so on;
a capture module 318 that is used for processing a respective image or video (or other data) captured by the capture device(s) 312, where the respective image or video may be sent to other edge devices and/or the server system 200;
a location detection module 320 (e.g., a GPS, Wi-Fi, or hybrid positioning module) that is used for determining the location of the edge device 300 (e.g., using the location detection device 310) and providing this location information to other edge devices and/or the server system 200;
a defect detection module 322 that is used for detecting product defects and other production line defects using data captured by the capture devices 312;
a gesture sequence capture module 324 that is used for capturing a gesture sequence of an operator (e.g., a robot 502 (FIG. 5) or a human worker) of the production line; and
a database 326 for storing data associated with the edge device 300, such as:
   one or more classification models 328;
   one or more gesture sequences 330;
   one or more dynamic time wrapping processes 332; and
   content 334.

In some implementations, the content 334 includes data captured by the capture device(s) 312, as well as models and views generated by the edge device 300. In some implementations, the content 334 includes text (e.g., ASCII, SGML, HTML), images (e.g., jpeg, tif and gif), graphics (e.g., vector-based or bitmap), audio, video (e.g., mpeg), other multimedia, and/or combinations thereof.

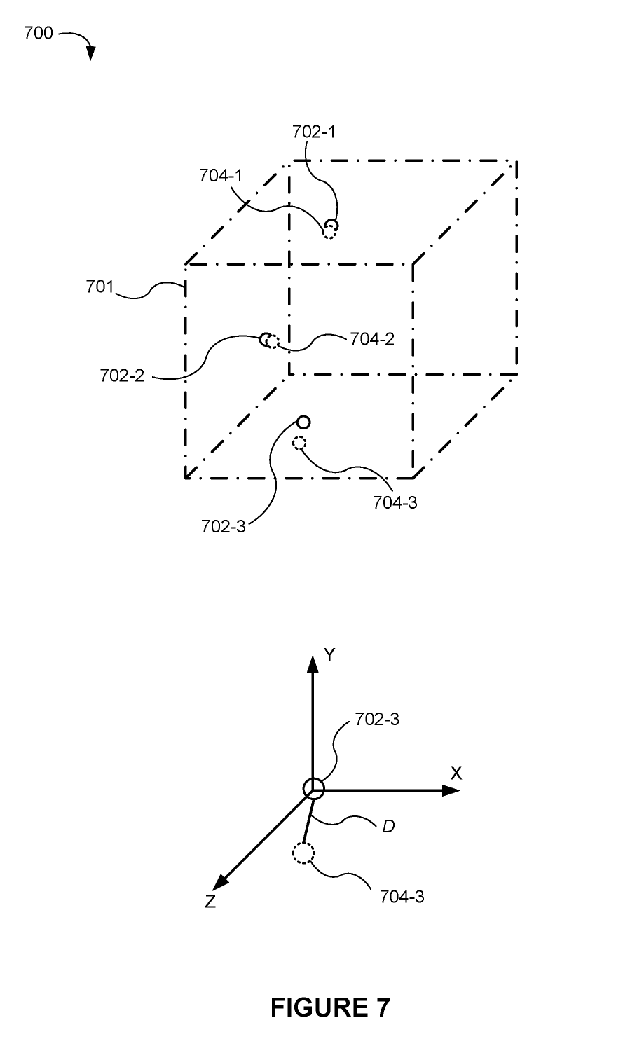

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various implementations. In some implementations, memory 206 and/or 306 store a subset of the modules and data structures identified above. Furthermore, memory 206 and/or 306 optionally store additional modules and data structures not described above. For example, memory 206 and/or 306 may store one or more equations, provided below with reference to FIG. 7. In some implementations, the one or more equations are part of the DTW processes 222 and/or DTW processes 332.

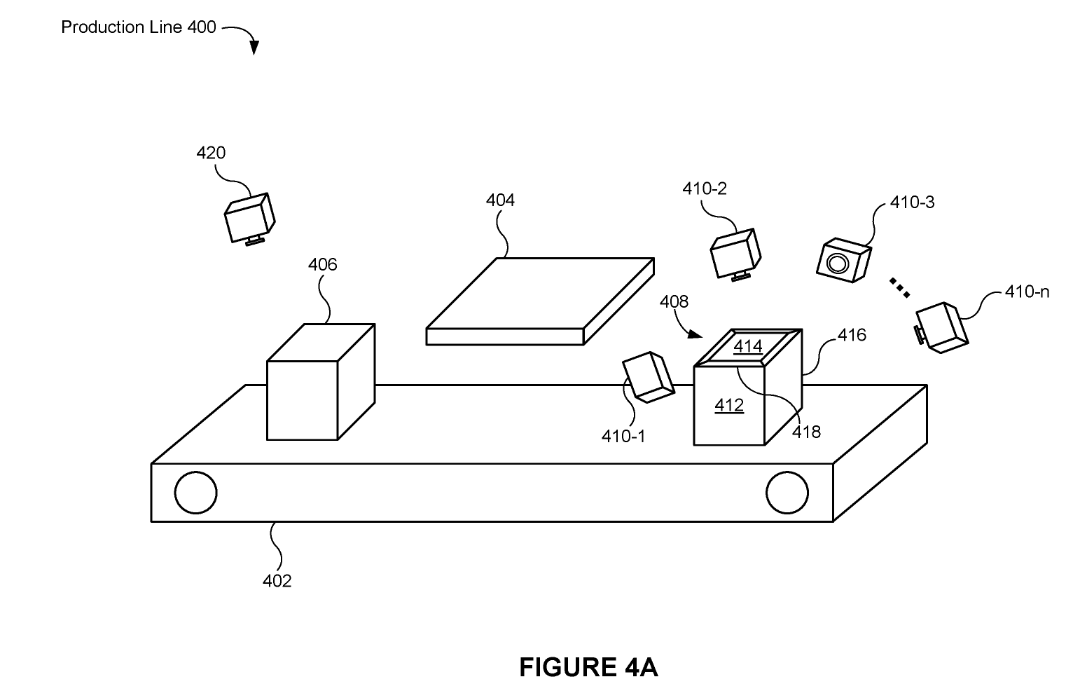

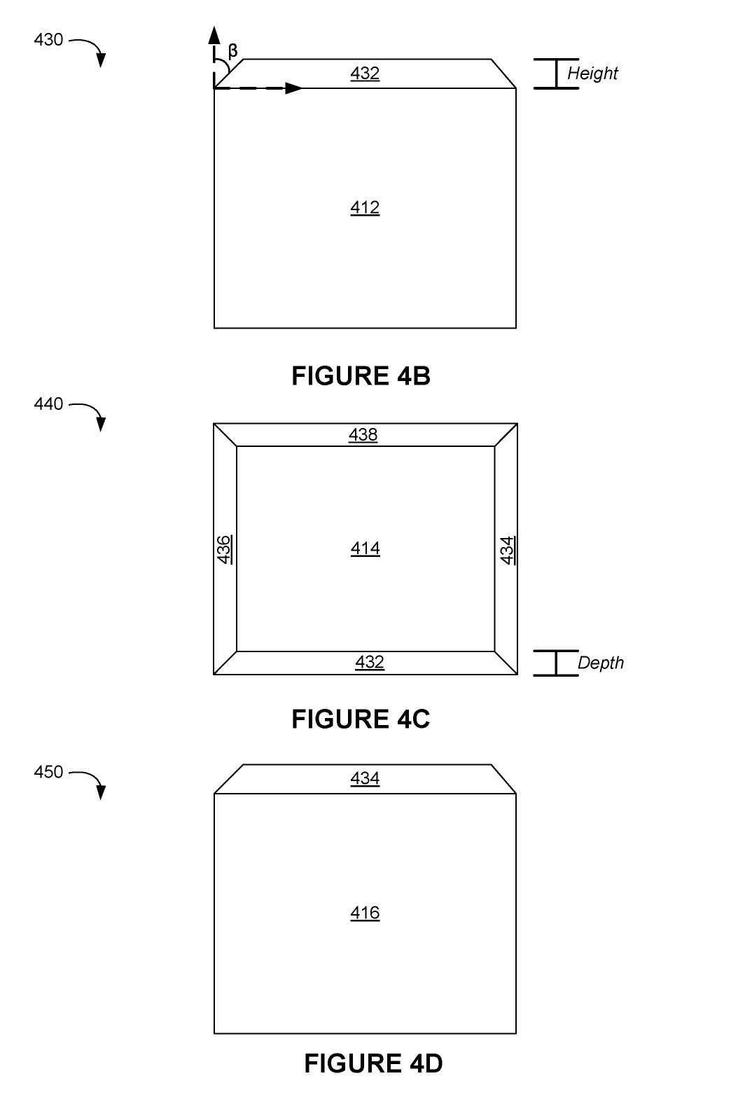

FIG. 4A is an exemplary arrangement of a plurality of edge devices on a production line, in accordance with some implementations.

The production line 400 includes a work surface 402. In some implementations, the work surface 402 conveys products through the production line 400. Although not shown, in some implementations, the work surface 402 may continue is both directions such that additional operations are included in the production line 400. Moreover, the implementations described herein apply equally to non-assembly line based manufacturing processes. In such cases, the work surface 402 is stationary. For example, the work surface 402 may be a surface of a three-dimensional printer, a computer numerical control mill, or any other non-assembly line based manufacturing process. For ease of discussion, these non-assembly line based manufacturing processes will be referred to as the production line 400.

The production line 400 includes an operation 404 (e.g., a process/action that contributes to fabricating a product). In some implementations, the production line 400 includes multiple operations. It should be noted that although a chamfering operation is discussed below, the implementations described herein are applicable to any number of operations. The chamfering operation described below is simply used to provide context.

The production line 400 includes one or more products (e.g., a first product 406 and a second product 408) being fabricated. As shown, the first product 406 has not reached the operation 404 (e.g., in a first state) and the second product 408 has undergone the operation 404 (e.g., in a second state). As such, the second product 408 has a chamfered edge 418, whereas the first product 406 does not.

The production line 400 includes edge devices 410-1, 410-2, 410-3, . . . 410-n. In some implementations, the edge devices 410-1, 410-2, 410-3, . . . 410-n are examples of the edge devices 102-1, 102-2, . . . 102-n (FIG. 1). The edge devices 410-1, 410-2, 410-3, . . . 410-n inspect products on the production line (e.g., inspect for product defects) and analyze data collected during the inspection. In some implementations, a server system (e.g., server system 200, FIG. 2) provides each edge device with a classification model and each edge device uses the classification model to identify product defects. In some implementations, the classification model includes: (i) one or more characteristics of a reference product (e.g., an expected height, depth, and angle of the chamfered edge 418), and (ii) one or more identified defects associated with the operation 404 (and perhaps other defects associated with the production line 400). In some implementations, the classification model includes images of the reference product and the one or more characteristics are identified in the images. Alternatively or in addition, in some implementations, the classification model includes a computer model of the reference product and the one or more characteristics are identified in the computer model. Although the production line 400 illustrated in FIG. 4A includes multiple edge device, in some implementations, the production line 400 includes a single edge device.

To inspect the product 408, each edge device 410-1, 410-2, 410-3, . . . 410-n captures a unique perspective of the product 408. For example, the first edge device 410-1 captures a first unique perspective 430 (FIG. 4B) that includes a side surface 412 of the product 408, a second edge device 410-2 captures a second unique perspective 440 (FIG. 4C) that includes a top surface 414 of the product 408, and so on. In this way, the edge devices 410-1, 410-2, 410-3, . . . 410-n capture at least one resulting characteristic of the operation 404. For example, the first edge device 410-1 inspects the side surface 412 (e.g., for external and/or internal defects) and also a height (e.g., a first resulting characteristic, shown as “Height,” FIG. 4B) and an angle (e.g., a second resulting characteristic, shown as angle “β,” FIG. 4B) of a first portion 432 of the chamfered edge 418 (FIG. 4B). Moreover, the second edge device 410-2 inspects the top surface 414 (e.g., for external and/or internal defects) and also a depth (e.g., a third resulting characteristic, such as “Depth,” FIG. 4C) of each portion 432-438 of the chamfered edge 418. Another edge device captures unique perspective 450 (FIG. 4D) and inspects the front surface 416 (e.g., for external and/or internal defects) and also a height and an angle of a second portion 434 of the chamfered edge 418 (FIG. 4D). Additional edge devices may capture the other surfaces and other portions of the chamfered edge 418. For the sake of brevity, these will not be discussed.

Thereafter, each edge device 410-1, 410-2, 410-3, . . . 410-n compares its respective unique perspective with the classification model received from the server system (e.g., compares an image captured of its respective unique perspective with at least one image and/or the computer model included in the classification model). In some implementations, this involves comparing the at least one resulting characteristic of the operation 404 with the one or more characteristics included in the classification model. For example, the first edge device 410-1 compares the height (e.g., the first resulting characteristic, shown as “Height,” FIG. 4B) and the angle (e.g., the second resulting characteristic, shown as angle “β,” FIG. 4B) with corresponding characteristics included in the classification model. In some implementations, the classification model provided to a respective edge device is tailored to the unique perspective of the operation captured by the respective edge device. For example, the at least one image included in the classification model provided to the respective edge device is captured by the respective edge device (e.g., when creating the classification model).

In some implementations, each of the edge devices 410-1, 410-2, 410-3, . . . 410-n is positioned to capture a unique perspective of a most recent operation performed on the product (e.g., positioned to capture a unique perspective of the chamfered edge 418 of the product 408).

The edge devices 410-1, 410-2, 410-3, . . . 410-n use at least one capture device (e.g., capture device(s) 312, FIG. 3) to capture the unique perspective of the product 408. In some implementations, a first type of capture device (e.g., a camera, a depth camera, a video camera, three-dimensional camera, etc.) is used to identify a first type of product defect (e.g., surface defects) and a second type of capture device (e.g., an infrared camera, an X-ray camera, etc.) is used to identify a second type of product defect (e.g., internal defects). In some implementations, a respective edge device includes one or more of the first type of capture device or one or more of the second type of capture device. Alternatively, in some implementations, a respective edge device includes the first type of capture device and the second type of capture device. In some implementations, a first set of the edge devices includes one type of capture device while a second set of the edge devices includes a different type of capture device.

Because the edge devices 410-1, 410-2, 410-3, . . . 410-n have substantially less processing power relative to the server system 200 (FIG. 2), in some implementations, the edge devices 410-1, 410-2, 410-3, . . . 410-n send the data collected during inspection of the product 408 to the server system to leverage the processing power of the server system. In some implementations, the edge devices 410-1, 410-2, 410-3, . . . 410-n send the data to the server system at a predetermined interval, after identifying a product defect, or after identifying some other irregularity. In some instances, one or more edge devices identify a product defect using the classification model (e.g., the product defect is one of the identified product defects included in the classification model). In some other instances, one or more edge devices identify some irregularity (i.e., a potential product defect) that is not one of the identified product defects included in the classification model.

The server system processes the data received from the edge devices 410-1, 410-2, 410-3, . . . 410-n to potentially record and report the product defect. In some implementations, in processing the data, the server system analyzes individual unique perspectives of the product received from the edge device devices 410-1, 410-2, 410-3, . . . 410-n. Alternatively, in some implementations, the server system generates an overall view of the product by merging each unique perspective of the product captured by respective edge devices of edge devices 410-1, 410-2, 410-3, . . . 410-n. Generating the overall view includes creating a two-dimensional model or a three-dimensional model of the product. Thereafter, the server system compares the overall view (or the individual unique perspectives) with the reference product to identify a product defect (or multiple product defects). In some implementations, this comparison involves comparing each resulting characteristic identifiable in the overall view of the product with characteristics of the reference product. Alternatively or in addition, this comparison involves comparing each resulting characteristic identifiable in the overall view with the computer model of the reference product. Identifying product defects by the server system is described in further detail below with reference to method 800.

In those instances where the product defect is not one of the identified product defects included in the classification model, the server system updates the classification model to include the product defect and sends the updated classification model to the edge devices 410-1, 410-2, 410-3, . . . 410-n. Updating of the classification model by the server system is described in further detail below with reference to method 800.

After receiving the updated classification model form the server system, the edge devices 410-1, 410-2, 410-3, . . . 410-n continue to inspect products (e.g., the edge devices will inspect product 406, and other subsequent products). The edge devices 410-1, 410-2, 410-3, . . . 410-n compare respective unique perspectives with the updated classification model received from the server system. In this way, the production line 400 implements machine learning allowing the edge devices to dynamically identify and account for product defects (e.g., flag the defective product so that it does not enter the stream of commerce).

In some implementations, at least one edge device 420 is positioned before the operation 404. In some implementations, the at least one edge devices 420 performs the same functions as the edge devices 410-1, 410-2, 410-3, . . . 410-n. For example, the at least one edge device captures a unique perspective of the product 406 using at least one capture device. In some implementations, the at least one edge device 420 sends the data collected during inspection of the product 406 to the server system. The server system processes the data received from the at least one edge device 420 in the same manner discussed above with reference to the data received from the edge devices 410-1, 410-2, 410-3, . . . 410-n.

Although not shown, each of the edge devices 410-1, 410-2, 410-3, . . . 410-n is supported by a support apparatus or is mounted in some other manner. These supports or mounts have been removed for ease of illustration.

FIG. 5 is an exemplary arrangement of a plurality of edge devices on a production line 500 that includes an operator, in accordance with some implementations.

The production line 500 includes an operator, which in this case is a robot 502. However, in some implementations, the operator is a human operator. The robot 502 is configured to (i.e., programmed to) perform an operation on products (e.g., product 504). To perform the operation, the robot 502 executes a program stored in the robot's memory that causes the robot to perform the operation in a predefined gesture sequence. The robot 502 operates within a predefined three-dimensional space (e.g., coordinate system 701, FIG. 7) and movements of the robot 502 (or the human operator) within the three-dimensional space are referred to herein as a gesture sequence. In some implementations, the gesture sequence refers to an overall movement of the robot 502. Alternatively, in some implementations, the gesture sequence refers to movement of a part of the robot 502 (e.g., a specific joint or part of the robot 502).

Ideally, a gesture sequence of the robot 502 matches the predefined gesture sequence. However, for a variety of reasons, gesture sequences of the robot 502 overtime deviate from the predefined gesture sequence. Deviation from the predefined gesture sequence can result in product defects. Edge devices can be used to identify deviations from the predefined gesture sequence, and data collected by the edge devices can further be used to recalibrate the robot 502.

The production line 500 includes a first set of edge devices 504-1, 504-2, 504-3, . . . 504-n. Each of the edge devices in the first set 504-1, 504-2, 504-3, . . . 504-n is an example of the edge device 300 (FIG. 3). The first set of edge devices 504-1, 504-2, 504-3, . . . 504-n inspects products on the production line 500 (e.g., inspects product 505 for product defects) and analyzes data collected during the inspection. In doing so, each edge device in the first set 504-1, 504-2, 504-3, . . . 504-n captures a unique perspective of the product 505 and then compares its respective unique perspective with a classification model received from the server system, as discussed above with reference to FIGS. 4A-4D. In this example, the classification model received from the server system corresponds to one or more operations performed by the robot 502 (e.g., the robot 502 adds through-holes 507-A and 507-B to the product 505).

The production line 500 includes a second set of edge devices 506-1, 506-2, . . . 506-n. Each of the edge devices in the second set 506-1, 506-2, . . . 506-n is an example of the edge device 300 (FIG. 3). The second set of edge devices 506-1, 506-2, . . . 506-n inspects the operator (e.g., the robot 502) of the production line 500 (e.g., inspect movements of the robot 502 or movements of a human operator/worker) and analyzes data collected during the inspection. Each of the edge devices in the second set 506-1, 506-2, . . . 506-n uses at least one capture device (e.g., capture device(s) 312, FIG. 3) to inspect the operator. In some implementations, the first set of edge devices 504-1, 504-2, 504-3, . . . 504-n and the second set of edge devices 506-1, 506-2, . . . 506-n use the same capture device(s). Alternatively, in some implementations, the first set of edge devices 504-1, 504-2, 504-3, . . . 504-n and the second set of edge devices 506-1, 506-2, . . . 506-n use at least one different capture device.

Data collected by the second set of edge devices 506-1, 506-2, . . . 506-n is used to identify a root cause of a product defect. As discussed above, the first set of edge devices 504-1, 504-2, 504-3, . . . 504-n identifies a product defect (or the server system 200 identifies the product defect). In some implementations, identification of a product defect triggers the second set of edge devices 506-1, 506-2, . . . 506-n to inspect a most recent gesture sequence of the robot 502 (or multiple prior gesture sequences of the robot 502) to determine if the robot 502 caused the product defect. Alternatively, in some implementations, the second set of edge devices 506-1, 506-2, . . . 506-n inspects the most recent gesture sequence (or multiple prior gesture sequences) of the robot 502 by default.

In some implementations, the server system provides each edge device with a predefined gesture sequence for the operation performed by the robot 502. In some implementations, the predefined gesture sequence is a series of images (or a video) of the robot 502 performing the operation taken from multiple unique perspectives (e.g., a quality engineer records the robot 502 successfully performing the operation from different angles). In some implementations, the predefined gesture sequence is captured using the second set of edge devices 506-1, 506-2, . . . 506-n. Alternatively, in some implementations, the predefined gestured sequence is a computer program simulating the robot 502 performing the operation. As discussed below, the second set of edge devices 506-1, 506-2, . . . 506-n uses the predefined gestured sequence received from the server system to determine if the robot 502 caused the product defect.

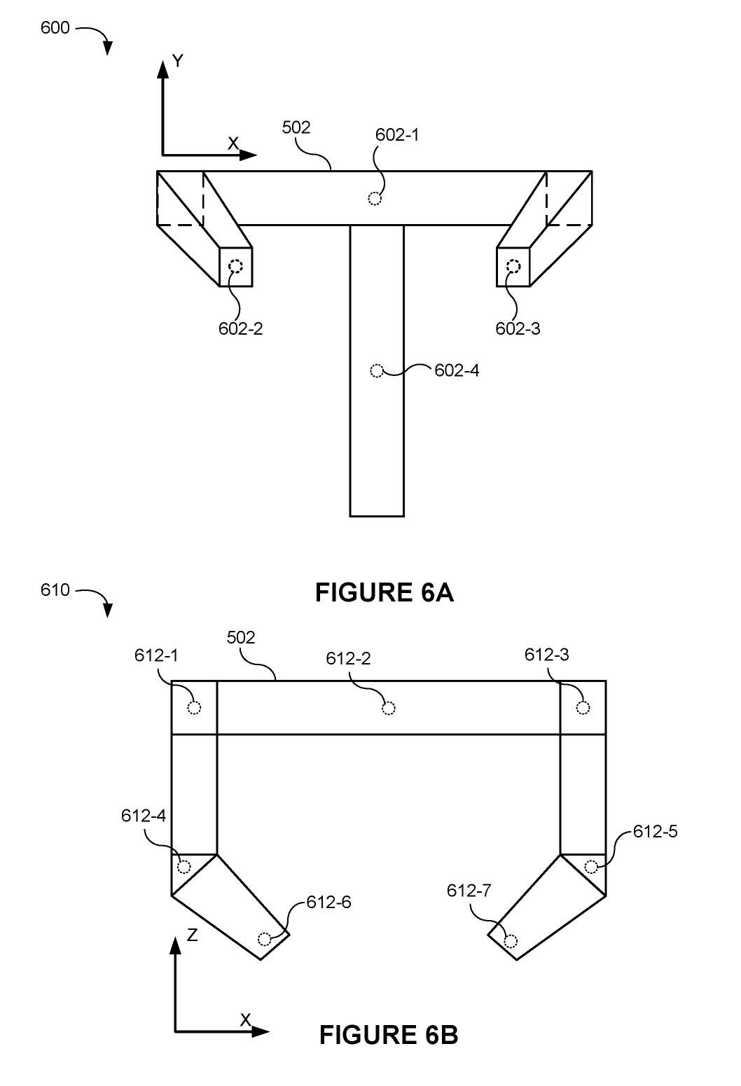

To inspect movements of the robot 502, each edge device in the second set 506-1, 506-2, . . . 506-n captures a gesture sequence of the robot 502 performing the operation from a unique perspective. For example, a first edge device 506-1 of the second set captures a gesture sequence (e.g., a front perspective taken along line A, shown in FIG. 6A) of the robot 502, a second edge device 506-2 of the second set captures a second gesture sequence (e.g., a top perspective taken along line B, shown in FIG. 6B) of the robot 502, and so on. In some implementations, capturing a gesture sequence of the robot 502 includes capturing multiple images (or recording a video) of the robot 502 performing the operation. Subsequently, each edge device in the second set 506-1, 506-2, . . . 506-n compares its respective gesture sequence with the predefined gesture sequence received from the server system (e.g., compares its captured sequence of images with the sequence of images (or the computer program) of the predefined gesture sequence).

In some implementations, instead of the second set of edge devices 506-1, 506-2, . . . 506-n performing the comparison, the second set of edge devices 506-1, 506-2, . . . 506-n sends data to the server system (e.g., the captured gesture sequences) and the server system performs the comparison.

In some implementations, the predefined gesture sequence includes desired locations (e.g., programmed locations) of the robot 502 for a particular key frame. A “key frame” refers to a pivotal moment of the operation performed by the robot 502 (e.g., point in time when the robot 502 contacts the product 408, point in time when the robot 502 contacts a component to add to the product 408, etc.). In some implementations, the predefined gesture sequence includes a plurality of key frames. For example, at a point in time during the operation (e.g., a first key frame), a desired location of a tool (e.g., a drill tip used to drill the through-holes 507-A and 507-B) of the robot 502 is a first set of coordinates (e.g., an x-coordinate, a y-coordinate, and a z-coordinate) and a desired location of an elbow joint of the robot 502 is a second set of coordinates.

In some implementations, each edge device in the second set 506-1, 506-2, . . . 506-n (or the server system) compares one or more actual locations in a gesture sequence of the robot 502 with one or more corresponding desired locations of the robot 502 of a particular key frame included in the predefined gesture sequence. For example, FIG. 6A is a first image 600 of a gesture sequence of the robot 502 captured by the first edge device 506-1 indicating actual locations 602-1-602-4 of the robot 502 in the X-Y plane (e.g., actual locations of different parts of the robot 502). The first edge device 506-1 may compare the actual locations 602-1-602-4 of the robot 502 with corresponding desired locations of the robot 502 for a particular key frame included in the predefined gesture sequence. In doing so, the first edge device 506-1 determines a difference (e.g., a coordinal difference) between the actual locations 602-1-602-4 and the desired (e.g., programmed) locations of the robot 502.

Similarly, FIG. 6B is a second image 610 of the gesture sequence of the robot 502 captured by the second edge device 506-2 indicating actual locations 612-1-612-7 of the robot 502 in the Z-X plane, where the first image and the second image are captured simultaneously. The second edge device 506-2 may compare the actual locations 612-1-612-7 of the robot 502 with corresponding desired locations of the robot 502 for the particular key frame. In doing so, the second edge device 506-2 determines a difference (e.g., a coordinal difference) between the actual locations 612-1-612-7 and the desired (e.g., programmed) positions included in the predefined gesture sequence.

In some implementations, the server system, instead of the edge devices, compares the actual locations of the robot 502 with the corresponding desired locations of the robot 502 for a particular key frame.

In some implementations, the server system (or a designated edge device) combines gesture sequences (or particular images from gestured sequences) to create a three-dimensional model of the movements of the robot 502. For example, the first image 600 of the gesture sequence captured by the first edge device 506-1 is a two-dimensional image in the X-Y plane and the second image 610 of the gesture sequence captured by the second edge device 506-2 is a two-dimensional image in the Z-X plane. Accordingly, the first 600 and second 610 images are combined (e.g., merged) to create a three-dimensional model, at least for the particular key frame (additional images captured by other edge devices in the second set, e.g., one or more two-dimensional images in the Z-Y plane, or other planes, can also be used to create the three-dimensional model). An exemplary three-dimensional model generated by the server system (or the designated edge device) is illustrated in FIG. 7.

FIG. 7 illustrates an exemplary three-dimensional model 700 of movements of an operator during a period of time, in accordance with some implementations. As noted above, the server system creates the three-dimensional model 700 using images (or videos) captured by and received from edge devices. The three-dimensional model 700 includes a coordinate system 701 (e.g., robot 502 operates within the coordinate system 701), which includes desired locations (e.g., programmed locations) for an operator performing an operation (e.g., desired locations of the predefined gesture sequence) and actual locations (e.g., locations derived from multiple captured gesture sequences) of the operator performing the operation (e.g., a tool (or some other part) of the robot 502 captured at three different locations, FIG. 5).

In some implementations, the coordinate system 701 is viewed as having a first desired location 702-1 at a first time (e.g., a first key frame) for a first portion of the operation, a second desired location 702-2 at a second time (e.g., a second key frame) for a second portion of the operation, and a third desired location 702-3 at a third time (e.g., a third key frame) for a third portion of the operation. In addition, the coordinate system 701 includes a first actual location 704-1 at the first time for the first portion of the operation, a second actual location 704-2 at the second time for the second portion of the operation, and a third actual location 704-3 at the third time for the third portion of the operation.

Alternatively, in some implementations, the coordinate system 701 is viewed as having a desired location 702-1 of a first part (e.g., a shoulder joint) of the operator at a first time, a desired location 702-2 of a second part (e.g., an elbow joint) of the operator at the first time, a desired location 702-3 of a third part (e.g., a tool) of the operator at the first time, and the corresponding actual locations of the first, second, and third parts of the operator at the first time. In other words, this view illustrates multiple joints/parts of the operator during a single key frame.

The first, second, and third actual locations of the operator are determined using the gesture sequences captured by the edge devices, as discussed above in FIGS. 5 and 6A-6B. In some implementations, the desired locations and the actual locations each include a set of coordinates (e.g., an x-axis direction component, a y-axis directional component, and a z-axis direction component) of the coordinate system 701.

In some implementations, the server system (or one of the edge devices) determines distances between the desired locations and the actual locations. This is accomplished by determining a difference between each directional component (e.g., an x-axis direction component, a y-axis directional component, and a z-axis direction component) of an actual location and a corresponding desired location. In some implementations, determining the distance between the actual location and the corresponding desired location is represented by the following equation:

Distance=\sqrt{(x₁ⁱ−x₂ⁱ)²+(y₁ⁱ−y₂ⁱ)²+(z₁ⁱ−z₂ⁱ)²}

where x₁ⁱ is an x-coordinate value for the desired location of part i (e.g., elbow joint) of the operator and x₂ⁱ is an x-coordinate value for the actual location of the part i of the operator, and so on. As such, a distance “D” between the desired location 702-3 and the actual location 704-3, as an example, is determined by inputting x, y, and z-coordinate values for the desired location 702-3 and x, y, and z-coordinate values for the actual location 704-3 into the equation above.

In some implementations, the server system compares each of the determined distances with one or more thresholds. The server system records and reports behavior (e.g., a gesture sequence) of the operator as being abnormal upon determining that the distance between the actual location and the corresponding desired location satisfies one of the one or more thresholds. It should be noted that, in some implementations, the server system (or one of the edge devices) determines distances between desired locations and actual locations of the operator after identifying a product defect (as discussed above with reference to FIGS. 4A-4D). The purpose being to determine if the operator caused the identified product defect.

In some implementations, the server system (or each of the edge devices) applies a dynamic time wrapping (DTW) process to the gesture sequence of the operator. The DTW process is a time series analysis tool for measuring similarity between two temporal sequences which may vary in the temporal domain by calculating an optimal match between two given sequences (e.g. time series) with certain restrictions. The sequences are “warped” non-linearly in the time dimension to determine a measure of their similarity independent of certain non-linear variations in the time dimension. This sequence alignment method is often used in time series classification. In some implementations, besides a similarity measure between the two sequences, a so called “warping path” is produced by warping according to this path the two signals may be aligned in time such that the signal with an original set of points X(original), Y(original) is transformed to X(warped), Y(original). For example, the DTW process may normalize a temporal difference between the predefined gesture sequence and the gesture sequence of the operator. This is particular useful when the operator is a human operator. For example, when human operators are involved, the predefined gesture sequence may be based on actions of a first human operator (e.g., one or more edge devices may record actions/movements of the first human operator performing the operation in order to create the predefined gesture sequence for the operation). Moreover, the gesture sequence of the operator may be a gesture sequence of a second human operator, who works at a different pace from a pace of the first human operator (i.e., a temporal difference exists between the predefined gesture sequence and the gesture sequence of the second human operator). Thus, the DTW process normalizes this temporal difference. In this way, the actual locations of the operator can be aligned with desired locations for a particular key frame included in the predefined gesture sequence. In doing so, distances between the desired locations and the actual locations may be accurately determined. In some instances, if the temporal difference is not normalized, the server system cannot align an actual location with a corresponding desired location for the particular key frame.

In some implementations, determining a distance between the actual location and the corresponding desired location using the DTW process is represented by the following equation:

$${Distance}_{k ∈ N} = {\sum }_{f ∈ F} {\sum }_{i ∈ I} dis ( i , f )$$

where k is a template index (e.g., templates for various operators), N is a template number (e.g., a template for a specific operator, i.e., a predefined gesture sequence of the specific operator), F is the skeleton frame number (e.g., a skeleton of the specific operator, which includes a plurality of parts (e.g., joints, tools, etc.) for the specific operator), I is the skeleton part number, and dis(i,f) is the distance between a desired location of part i (e.g., one of the plurality of parts for the specific operator) and an actual location of the part i for frame number f (e.g., key frame f). The dis(i,f) can be represented by the following equation:

Dis(i, f)=\sqrt{(x₁ⁱ−x₂ⁱ)²+(y₁ⁱ−y₂ⁱ)²+(z₁ⁱ−z₂ⁱ)²}

where x₁ⁱ is an x-coordinate value for the desired location of the part i for frame number f and x₂ⁱ is an x-coordinate value for the actual location of the part i for frame number f, and so on.

In some implementations, the server system (or one of the edge devices) records and reports behavior of the operator as being abnormal upon determining that a distance, for key frame f, between the desired location and the actual location satisfies a threshold. In doing so, the operator is reported as a candidate for causing the product defect. For example, as shown in FIG. 7, the distance “D” between the third actual location 704-3 and the third desired location 702-3 satisfies the threshold. As such, the operator is reported as having abnormal behavior, at least for the third actual location 704-3 of the gesture sequence.

Accordingly, the server system may take appropriate action to prevent the abnormal behavior from occurring again in the future. For example, when the operator is a robot, the server system updates a program defining the gesture sequence of the robot. In another example, when the operator is a human operator, the server system provides a report to the human operator that highlights the human operator's abnormal behavior. The human operator may then adjust his or her future behavior based on information included in the report. Recording and reporting the operator is discussed in further detail below with reference to method 800.

In some implementations, the DTW process includes comparing template vectors and captured (e.g., actual) vectors between key frames. For example, this DTW process involves determining a template vector between desired locations 702-1 and 702-1 and also determining a captured vector between actual locations 704-1 and 704-2. After the vectors are determined, the server system compares the template vector with the captured vector and identifies a difference, if any, between the vectors. In some implementations, determining a template vector using the DTW process is represented by the following equation:

V_{template,i}=Δx_{f·f+1}, Δy_{f·f+1}, Δz_{f·f+1}

where V_{template,i} is a template vector of joint i (e.g., elbow joint) between frame f and frame (f+1). Determining a captured vector (V_{captured,i}) is represented by a similar equation. After the template vector and the captured vector are determined, a distance between the two vectors is determined, using the following equation:

$${Distance}_{k ∈ N} = {\sum }_{f ∈ F} {\sum }_{i ∈ I} dis ( {V}_{template , i} , {V}_{captured , i} )$$

where k is a template index, N is a template number, F is the skeleton frame number, I is the skeleton part number, and dis(V_{template,i}, V_{captured,i}) is the distance between the template vector of joint i (e.g., elbow joint) between frame f and frame f+1 and the captured vector of joint i (e.g., elbow joint) between frame f and frame f+1. In some implementations, the coordinate systems used for determining the template vector and the captured vector are shifted with their centers translated to the abdomen joint of the human or robot. As part of the DTW process, this step can improve the accuracy of the DTW process when comparing the similarity of the two vectors.

In some implementations, the server system (or one of the edge devices) records and reports behavior of the operator as being abnormal upon determining that the distance between the template vector and the captured vector satisfies a threshold, as discussed above.

In some implementations, thresholds set for human operators are more forgiving versus thresholds set for robots. In other words, larger distances (e.g., distance “D”) between the actual location and the corresponding desired location (or vectors) are permissible when human operators are involved. The equations provided above may be stored in memory of the server system (e.g., in database 220, FIG. 2) and/or memory of each of the edge devices (e.g., in database 326, FIG. 3).

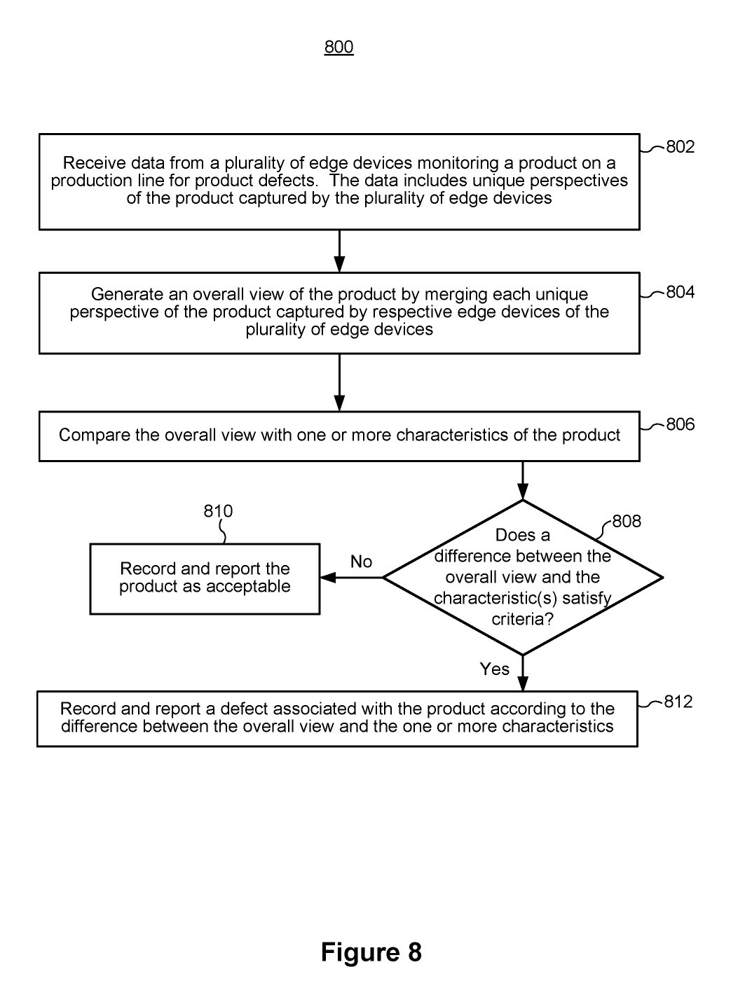

FIG. 8 is a flow diagram illustrating a method 800 of improved quality inspection on a production line, in accordance with some implementations. The steps of the method 800 may be performed by a server system (e.g., server system 104, FIG. 1; server system 200, FIG. 2). FIG. 8 corresponds to instructions stored in a computer memory or computer readable storage medium (e.g., memory 206 of the server system 200). For example, the operations of the method 800 are performed, at least in part, by a communications module (e.g., communications module 212, FIG. 2) a generating module (e.g., generating module 214, FIG. 2), an analyzing module (e.g., analyzing module 216, FIG. 2), and a reporting module (e.g., reporting module 218, FIG. 2). In some implementations, the steps of the method 800 may be performed by any combination of one or more edge devices (e.g., edge devices 102-1, 102-2, . . . 102-n, FIG. 1; edge device 300, FIG. 2) and the server system. In addition, in some implementations, one or more steps of the method 800 may be performed by one or more edge devices.

In performing the method 800, the server system receives (802) data from a plurality of edge devices (e.g., edge devices 102-1, 102-2, . . . 102-n, FIG. 1) monitoring a product (e.g., the second product 408, FIG. 4A) on a production line (e.g., production line 400, FIG. 4A) for product defects. The data includes unique perspectives of the product captured by the plurality of edge devices (e.g., unique perspectives 430, 440, and 450, FIGS. 4B-4D). Each of the plurality of edge devices is positioned to visually inspect a respective portion (or multiple portions) of the product. In some implementations, one or more of the unique perspectives at least partially overlap. In this way, the edge devices collectively capture a comprehensive view of the product.

In some implementations, the data received from the plurality of edge devices includes one or more images (e.g., jpeg and the like) of each unique perspective of the product captured by respective edge devices of the plurality of edge devices. Alternatively or in addition, in some implementations, the data received from the plurality of edge devices includes one or more videos (e.g., mpeg and the like), or some other visual-based data files, of each unique perspective of the product captured by respective edge devices of the plurality of edge devices. In some implementations, data captured by the plurality of edge devices is captured simultaneously by the plurality of edge devices (e.g., each edge device in the plurality captures a first image at a first time, a second image at a second time, and so).

In some implementations, the plurality of edge devices monitors the product for surface (i.e., visual) defects, such as a scratches, blemishes, visible cracks, abrasion, corrosion, debris, operational defects (e.g., defects associated with a characteristic or feature created by an operation, such as defects associated with the chamfered edge 418, FIG. 4A), etc. To monitor the product for surface defects, each of the plurality of edge devices uses at least one capture device (e.g., capture devices 312, FIG. 3) to collect the data. For surface defects, the capture device may be one or more of a camera, a depth camera, a three-dimensional camera (e.g., a stereo vision camera), a video camera, and the like.

Alternatively or in addition, in some implementations, the plurality of edge devices monitors the product for internal (i.e., non-visible) defects, such as internal cracking, variation in wall thickness, hot spots, placement of internal component, etc. To monitor the product for internal defects, each of the plurality of edge devices uses at least one capture device (e.g., capture devices 312, FIG. 3) to collect the data. For internal defects, the capture device may be one or more of an X-ray camera, an infrared camera, and the like.

The server system generates (804) an overall view of the product by merging each unique perspective of the product captured by respective edge devices of the plurality of edge devices. In those implementations where the data received from the plurality of edge devices includes images of each unique perspective of the product, merging each unique perspective of the product includes merging at least some of the images captured by the plurality of edge devices according to their respective physical locations to generate the overall view. For example, if a first edge device is left (i.e., west) of a second edge device, then the server system merges a right edge of a first image of a first unique perspective captured by the first edge device with a left edge of a second image of a second unique perspective captured by a second edge device. This process is repeated for each edge device in the plurality of edge devices to either create a two-dimensional model or a three-dimensional model of the product. In some implementations, the server system determines the location of a respective edge device using location data captured by a location detection device 310 (FIG. 3) of the respective edge device. In some implementations, the server system determines the location of a respective edge device using an identifier of the respective edge device included in the received data (e.g., the identifier corresponds to a location in a location table stored in memory 206, FIG. 2).

Alternatively or in addition, in some implementations, the server system mergers the unique perspectives based on content of the data. For example, the server system may determine that a left portion of a first image is similar to a right portion of a second image. Based on this determination, the server system merges the left portion of the first image with the right portion of the second image. This process is repeated for each received image to either create a two-dimensional model or a three-dimensional model of the product (e.g., similar process to creating a panoramic image).

The server system compares (806) the overall view with one or more characteristics (e.g., features) of the product. The one or more characteristics of the product are expected results of an operation performed on the product. For example, referring to FIG. 4A, the operation 404 chamfers an edge 418 of the product 408. As such, the one or more characteristics of the product 408, at least those characteristics resulting from the operation 404, include the chamfered edge 418 of the product 408 (e.g., each of the four edges is chamfered, and the one or more characteristics correspond to specific dimensions of the four chamfered edges). In another example, the one or more characteristics of the product 408 include surfaces with no surface defects (e.g., scratches, blemishes, etc.). In some implementations, the one or more characteristics are template (or reference) characteristics. In some implementations, the template characteristics are created during an initial registration process (e.g., a quality engineer registers dimensions of the chamfered edge 418, and other images of the product 408). Alternatively, in some implementations, the template characteristics are design specifications for the product.

In some implementations, comparing the overall view with one or more characteristics of the product includes extracting features of the product from the overall view and comparing those extracted features with at least one specific characteristic from the one or more characteristics of the products.

Continuing, the server system determines (808) whether a degree of difference between the overall view and the one or more characteristics satisfies one or more criteria, based on the comparing. The one or more criteria correspond to expected results of the operation, e.g., design specifications of the product and associated tolerances. For example, a respective criterion of the one or more criteria relates to a first feature and tolerances for the first feature (e.g., a drilled hole having a diameter of 1 centimeter, plus or minus 1 millimeter).

In some implementations, upon determining that the degree of difference between the overall view and the one or more characteristics does not satisfy at least one criterion of the one or more criteria (808—No), the server system records and reports (810) the product as acceptable (e.g., the product passes quality control). In doing so, the product either continues on the production line (e.g., subject to additional operations) or the product is removed from the production line and prepared for delivery/shipping.

In some implementations, upon determining that the degree of difference between the overall view and the one or more characteristics satisfies at least one criterion of the one or more criteria (808—Yes), the server system records and reports (812) a defect associated with the product according to the difference between the overall view and the one or more characteristics.

In some implementations, the server system classifies the defect associated with the product based at least part on (i) the data received from the plurality of edge devices, and (ii) the at least one criterion. The at least one criterion may be a template dimension of a characteristic created by an operation of the production line. For example, referring to FIG. 4A, the at least one criterion may require that an angle of the chamfered edge 418 be 45 degrees, plus or minus 1 degree. Accordingly, upon determining that the chamfered edge 418 has an angle of 47 degrees (e.g., angle “β” of the first portion 432, FIG. 4B), then the at least one criterion is satisfied. Based on the classification, the server system identifies at least one operation of the production line responsible for the defect (e.g., identifies the operation 404 as being responsible for the irregular angle of the chamfered edge 418). In some implementations, the at least one criterion relates to some other type defect (e.g., side A has no scratches or side A has a consistent sidewall thickness).

In some implementations, the server system provides a classification model to each of the plurality of edge devices for monitoring the product on the production line for product defects. The classification model may include one or more identified defects associated with the product. In some implementations, the classification model includes template/reference images of a template/reference product. For example, an operator (e.g., a quality engineer) may register template/reference images of a product that has passed quality control. The template/reference images may include the one or more characteristics, including those characteristics having dimensions and associated tolerances.

Furthermore, in some implementations, the server system: (i) updates the classification model to include the defect as part of the one or more identified defects associated with the product and (ii) provides the updated classification model to the plurality of edge devices after recording and reporting the defect. Each of the plurality of edge devices uses the updated classification model for monitoring the product (and subsequent products) on the production line for product defects, as discussed above with reference to FIGS. 4A-4D.

In some implementations, a respective edge device of the plurality of edge devices compares its respective unique perspective with the classification model received from the server system. In some circumstances, this involves comparing an image of the respective unique perspective with a template/reference image included in the classification model, where the template image corresponds to the respective unique perspective (e.g., the edge device measures features included in its respective unique perspective and compares those measurements with dimensions included in the template image). In some implementations, each edge device includes a corresponding comparison result in the data to be submitted to the server system.

In some implementations, at least one edge device of the plurality of edge devices identifies a product defect that is not one of the one or more identified defects associated with the product included in the classification model. In some implementations, identifying a product defect that is not one of the one or more identified defects associated with the product included in the classification model triggers inspection of one or more operators of the production line.

In some implementations, the data received from the plurality of edge devices spans a period of time. For example, the data may include a sequence of images spanning the period of time. In addition, the production line includes at least one operation (e.g., operation 404, FIG. 4A). In such a case, the data further includes a gesture sequence of an operator associated with the at least one operation captured by at least one edge device of the plurality of edge devices during the period of time. Capturing a gesture sequence of an operator is described in further detail above with reference to FIG. 5.

Furthermore, in some implementations, the server system compares the gesture sequence of the operator with a predefined gesture sequence corresponding to the operator. Based on the comparing, the server system determines whether a degree of difference between the gesture sequence of the operator and the predefined gesture sequence satisfies a threshold. Moreover, in accordance with a determination that the degree of difference between the gesture sequence of the operator and the predefined gesture sequence satisfies the threshold, the server system records and reports the operator as being associated with the defect. Alternatively, in accordance with a determination that the degree of difference between the gesture sequence of the operator and the predefined gesture sequence does not satisfy the threshold, the server system records and reports the operator as not being associated with the defect. The server system may subsequently compare a gesture sequence of a different operator with a predefined gesture sequence associated with the different operator. The process is repeated until an operator is identified that is associated with the defect (i.e., repeated until a cause of the defect is discovered).

In some implementations, the operator associated with the at least one operation is a robot (e.g., robot 502, FIG. 5). In such a case, recording and reporting the operator includes updating a program defining the gesture sequence of the robot. Alternatively or in addition, in some implementations, recording and reporting the operator includes resetting the robot.

In some implementations, the update modifies a specific portion of the gesture sequence, e.g., the gesture sequence associated with a specific joint/part and/or one or more specific movements while other portions of the gesture sequence remain unchanged. Furthermore, in some implementations, the updated program provided to the robot is updated based, at least in part, on the degree of difference between the gesture sequence of the operator and the predefined gesture sequence. Alternatively, in some implementations, the updated program provided to the robot is updated based, at least in part, on the degree of difference between a portion of the gesture sequence of the operator and a corresponding portion of the predefined gesture sequence. Determining a difference between the gesture sequence and the predefined gesture sequence is discussed in further detail above with reference to FIG. 7.

In some implementations, the operator associated with the at least one operation is a human operator. In such cases, recording and reporting the operator includes providing a report to the human operator (or perhaps a supervisor of the human operator). In this way, the human operator is notified of his or her error, thereby allowing the human operator to adjust his or her future actions so that the product defect no longer occurs. In addition, in some implementations, the report includes portions of the data received from the at least one edge device of the plurality of edge devices. For example, the report may include one or more images of the human operator working and/or one or more images of the product defect. In this way, the human operator is further notified of his or her error.

In some implementations, before comparing the gesture sequence of the operator with the predefined gesture sequence corresponding to the operator, the server system applies a dynamic time wrapping (DTW) process to the gesture sequence of the operator. The DTW process is a time series analysis tool for measuring similarity between two temporal sequences which may vary in the temporal domain by calculating an optimal match between two given sequences (e.g. time series) with certain restrictions. The sequences are “warped” non-linearly in the time dimension to determine a measure of their similarity independent of certain non-linear variations in the time dimension. This sequence alignment method is often used in time series classification. In some implementations, besides a similarity measure between the two sequences, a so called “warping path” is produced by warping according to this path the two signals may be aligned in time such that the signal with an original set of points X(original), Y(original) is transformed to X(warped), Y(original). For example, the DTW process may normalize a temporal difference between the predefined gesture sequence and the gesture sequence of the operator to improve its accuracy. This is particular useful when the operator is a human operator (note that the DTW process may also be applied to a robot operator). For example, the predefined gesture sequence may be based on actions of a first human operator (e.g., one or more edge devices may record actions/movements of the first human operator performing the operation in order to create the predefined gesture sequence for the operation). The gesture sequence included in the data provided to the server system may be a gesture sequence of a second human operator, who works at a different pace from a pace of the first human operator (i.e., a temporal difference exists between the predefined gesture sequence and the gesture sequence of the second human operator). Thus, the DTW process normalizes this temporal difference. Normalizing temporal differences using the DTW process is discussed in further detail above with reference to FIG. 7.

In some implementations, determining the degree of difference between the gesture sequence of the operator and the predefined gesture sequence is performed to the normalized temporal difference.

In some implementations, the overall view is a post-operation overall view and the data received from the plurality of edge devices includes: (i) a first sequence of images from each unique perspective of the product captured by a first set of edge devices of the plurality of edge devices before an operation, and (ii) a second sequence of images from each unique perspective of the product captured by a second set of edge devices of the plurality of edge devices after the operation. For example, referring to FIG. 4A, the at least one edge device 420 is positioned prior to the operation 404 and captures a first sequence of images of the second product 408. In addition, a second set of edge device 410-1, 410-2, 410-3, . . . 410-n positioned after the operation 404 capture a second sequence of images of the second product 408.

Continuing, in some implementations, the server system generates a pre-operation overall view of the product using the first sequence of images and the post-operation overall view is generated using the second sequence of images. In some circumstances, at least one characteristic of the one or more characteristics of the product is captured in the pre-operation overall view. Accordingly, if the defect is associated with the at least one characteristic, then the server system can rule out the operation 404 as being the cause of the product defect (e.g., some previous operation would have caused the defect).

In some implementations, the production line includes at least first and second operations and the data includes: (i) first unique perspectives of the product after the first operation captured by a first set of the plurality of edge devices, and (ii) second unique perspectives of the product after the second operation captured by a second set of the plurality of edge device. In such as case, the overall view is a first overall view of the first unique perspectives of the product after the first operation and the method further includes generating a second overall view of the product by merging each second unique perspective of the product captured by the second set of edge devices. Again, the server system can rule out the second operation as being the cause of the product defect if the product defect appears in the first overall view.

Although some of various drawings illustrate a number of logical stages in a particular order, stages which are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method performed by a server, comprising:
receiving data from a plurality of edge devices monitoring a product on a production line for product defects, wherein the data comprises unique perspectives of the product captured by the plurality of edge devices;
generating an overall view of the product by merging each unique perspective of the product captured by respective edge devices of the plurality of edge devices;
comparing the overall view with one or more characteristics of the product;
based on the comparing, determining whether a degree of difference between the overall view and the one or more characteristics satisfies one or more criteria; and
upon determining that the degree of difference between the overall view and the one or more characteristics satisfies at least one criterion of the one or more criteria, recording and reporting a defect associated with the product according to the difference between the overall view and the one or more characteristics.

2. The method of claim 1, further comprising:
providing a classification model to each of the plurality of edge devices for monitoring the product on the production line for product defects, wherein the classification model comprises one or more identified defects associated with the product and the edge device is configured to compare a unique perspective of the product with the classification model and include a corresponding comparison result in the data to be submitted to the server.

3. The method of claim 2, further comprising, after recording and reporting the defect:
updating the classification model to comprise the defect as part of the one or more identified defects associated with the product; and
providing the updated classification model to the plurality of edge devices, wherein each of the plurality of edge devices uses the updated classification model for monitoring the product on the production line for product defects.

4. The method of claim 1, wherein:
the data received from the plurality of edge devices spans a period of time;
the production line comprises at least one operation on the product; and
the data further comprises a gesture sequence of an operator associated with the at least one operation captured by at least one edge device of the plurality of edge devices during the period of time.

5. The method of claim 4, further comprising:
comparing the gesture sequence of the operator with a predefined gesture sequence corresponding to the operator;
based on the comparing, determining whether a degree of difference between the gesture sequence of the operator and the predefined gesture sequence satisfies a threshold; and
in accordance with a determination that the degree of difference between the gesture sequence of the operator and the predefined gesture sequence satisfies the threshold, recording and reporting the operator as being associated with the defect.

6. The method of claim 5, wherein:
the operator associated with the at least one operation is a robot; and
recording and reporting the operator comprises updating a program defining the gesture sequence of the robot.

7. The method of claim 6, wherein the updated program provided to the robot is updated based, at least in part, on the degree of difference between the gesture sequence of the operator and the predefined gesture sequence.

8. The method of claim 6, wherein the updated program provided to the robot is updated based, at least in part, on the degree of difference between a portion of the gesture sequence of the operator and a corresponding portion of the predefined gesture sequence.

9. The method of claim 5, wherein:
the operator associated with the at least one operation is a human operator;
recording and reporting the operator comprises providing a report to the human operator; and
the report comprises portions of the data received from the plurality of edge devices.

10. The method of claim 5, further comprising:
before comparing the gesture sequence of the operator with a predefined gesture sequence corresponding to the operator, applying a dynamic time wrapping (DTW) process to the gesture sequence of the operator;
wherein the DTW process normalizes a temporal difference between the predefined gesture sequence and the gesture sequence of the operator; and
determining the degree of difference between the gesture sequence of the operator and the predefined gesture sequence is performed to the normalized temporal difference.

11. The method of claim 1, wherein:
the data received from the plurality of edge devices comprises images of each unique perspective of the product captured by respective edge devices of the plurality of edge devices; and
merging each unique perspective of the product comprises merging at least some of the images captured by respective edge devices of the plurality of edge devices according to their respective physical locations along the production line to generate the overall view.

12. The method of claim 1, wherein:
the overall view is a post-operation overall view;
the data received from the plurality of edge devices comprises:
a first sequence of images from each unique perspective of the product captured by a first set of edge devices of the plurality of edge devices before an operation; and
a second sequence of images from each unique perspective of the product captured by a second set of edge devices of the plurality of edge devices after the operation;
the method further comprises generating a pre-operation overall view of the product using the first sequence of images;
the post-operation overall view is generated using the second sequence of images; and
at least some of the one or more characteristics of the product are captured in the pre-operation overall view.

13. The method of claim 1, further comprising:
classifying the defect associated with the product based at least part on (i) the data received from the plurality of edge devices and (ii) the at least one criterion; and
based on the classification, identifying at least one operation of the production line responsible for the defect.

14. The method of claim 1, wherein:
the production line comprises at least first and second operations;
the data comprises: (i) first unique perspectives of the product after the first operation captured by a first set of the plurality of edge devices, and (ii) second unique perspectives of the product after the second operation captured by a second set of the plurality of edge device;
the overall view is a first overall view of the first unique perspectives of the product after the first operation; and
the method further comprises generating a second overall view of the product by merging each second unique perspective of the product captured by the second set of edge devices.

15. The method of claim 1, wherein the plurality of edge devices comprises one or more of: a camera, an infrared camera, an X-ray camera, and a depth camera.

16. A server system, comprising:
one or more processors; and
memory storing one or more programs for execution by the one or more processors, the one or more programs including instructions for:
receiving data from a plurality of edge devices monitoring a product on a production line for product defects, wherein the data comprises unique perspectives of the product captured by the plurality of edge devices;
generating an overall view of the product by merging each unique perspective of the product captured by respective edge devices of the plurality of edge devices;
comparing the overall view with one or more characteristics of the product;
based on the comparing, determining whether a degree of difference between the overall view and the one or more characteristics satisfies one or more criteria; and
upon determining that the degree of difference between the overall view and the one or more characteristics satisfies at least one criterion of the one or more criteria, recording and reporting a defect associated with the product according to the difference between the overall view and the one or more characteristics.

17. The server system of claim 16, wherein:
the data received from the plurality of edge devices spans a period of time;
the production line comprises at least one operation on the product; and
the data further comprises a gesture sequence of an operator associated with the at least one operation captured by at least one edge device of the plurality of edge devices during the period of time.

18. The server system of claim 17, wherein the one or more programs further include instructions for:
comparing the gesture sequence of the operator with a predefined gesture sequence corresponding to the operator;
based on the comparing, determining whether a degree of difference between the gesture sequence of the operator and the predefined gesture sequence satisfies a threshold; and
in accordance with a determination that the degree of difference between the gesture sequence of the operator and the predefined gesture sequence satisfies the threshold, recording and reporting the operator as being associated with the defect.

19. The server system of claim 18, wherein:
the operator associated with the at least one operation is a robot; and
recording and reporting the operator comprises updating a program defining the gesture sequence of the robot.

20. A non-transitory computer-readable storage medium, storing one or more programs configured for execution by one or more processors of a server system, the one or more programs including instructions, which when executed by the one or more processors cause the server system to:
receive data from a plurality of edge devices monitoring a product on a production line for product defects, wherein the data comprises unique perspectives of the product captured by the plurality of edge devices;
generate an overall view of the product by merging each unique perspective of the product captured by respective edge devices of the plurality of edge devices;
compare the overall view with one or more characteristics of the product;
based on the comparing, determine whether a degree of difference between the overall view and the one or more characteristics satisfies one or more criteria; and
upon determining that the degree of difference between the overall view and the one or more characteristics satisfies at least one criterion of the one or more criteria, record and report a defect associated with the product according to the difference between the overall view and the one or more characteristics.
